(19) United States
(12) Patent Application Publication
(10) Pub. No.: US 2008/0024249 A1
(43) Pub. Date: Jan. 31, 2008

(54) High-Frequency Filter

(75) Inventor: Gerhard Schreibvogel, Worgl (AT)

Correspondence Address: NIXON & VANDERHYE, PC, 901 NORTH GLEBE ROAD, 11TH FLOOR, ARLINGTON, VA, 22203, US

(73) Assignee: KATHREIN-AUSTRIA GES.M.B.H., Kufstein (AT)

(21) Appl. No.: 11/663,058

(22) PCT Filed: Sep. 15, 2005
(86) PCT No.: PCT/EP05/09939

§ 371 Date: Jul. 25, 2007

(30) Foreign Application Priority Data
Sep. 16, 2004 (DE) 10 2004 045 006.4

(51) Int. Cl. H01P 1/20

(52) U.S. Cl. 333/222; 333/219.1

(57) ABSTRACT

The invention relates to a high-frequency filter that has the following features: a substrate is provided that is made of dielectric material and comprises a first face and an opposite second face; at least one stripline is applied to the first face of the substrate; at least one resonator is provided which is electrically coupled to the at least one stripline; a ground area is provided that is spaced apart from the stripline; the at least one resonator is embodied as a coaxial resonator comprising an outer conductor pot and a substantially rod-shaped inner conductor which is disposed coaxially in the outer conductor pot; the outer conductor pot is galvanically connected to the ground area; a first end of the inner conductor is galvanically connected to the bottom of the outer conductor pot; the resonator is electrically coupled to the at least one stripline via an opposite second end of the inner conductor.

The invention relates to a high-frequency filter in accordance with the preamble to claim 1.

In technical radio systems, especially in the mobile radio sector, a common antenna is frequently used for transmission and reception signals. In this situation, the transmission and reception signals in each case use different frequency ranges, and the antenna must be suitable for sending and receiving in both frequency ranges. To separate the transmission and reception signals, a suitable frequency filtering arrangement is therefore required, with which on the one hand the transmission signals are forwarded from the transmitter to the antenna and, on the other, the reception signals are forwarded from the antenna to the receiver. To separate the transmission and reception signals, use is made nowadays of high-frequency filters.

From the prior art high-frequency filters in coaxial design are known. An example of such a coaxial resonator is demonstrated in the prior publication “Theory and Design of Microwave Filters”, Ian Hunter, Electromagnetic Waves Series 48, year of publication 2001, page 197. Such coaxial resonators are narrow-band filters with steep flanks. These filters are usually metallic cast or milled components with resonator cavities, electrically coupled to metal wires. These conventional coaxial resonators have the disadvantage that they are relatively expensive to manufacture and have large dimensions.

From the prior art, stripline filters are also known which are perceptibly broader band than filters of coaxial design. A conventional stripline filter is demonstrated in the prior publication “Microstrip Filters for RF/Microwave Applications”, Jia-Sheng Hong and M. J. Lancaster, year of publication 2001, especially in FIG. 6.5 on page 170. In that case, an electric lead is reproduced in stripline technology, wherein provided adjacent to this lead at short intervals is a plurality of U-shaped resonators or straight resonators, i.e. running in strip fashion. The straight running resonators or the limbs of the U-shaped resonators run in this situation at right angles to the lead in the shape of a stripline. The lateral interval spacing of the individual resonators in the direction of the stripline in each case amounts to λ/4. Filters in stripline technology are considerably easier to manufacture than filters of coaxial design, but stripline filters are substantially broader band.

The object of the invention is to provide a narrow-band high-frequency filter which is easier to manufacture in comparison with conventional coaxial high-frequency filters, and has a compact design.

This object is resolved by the high-frequency filter as claimed in the independent claim 1. Further embodiments of the invention are defined in the dependent claims.

The high-frequency filter as claimed in the invention comprises a substrate of dielectric material with a first side and an opposite second side, wherein on the first side of the substrate at least one electrically conductive bus strip is located. This bus strip is electrically coupled to at least one resonator, wherein the resonator is not designed as a bus strip, but as a coaxial resonator with an outer conductor container and an essentially rod-shaped inner conductor arranged coaxially in the outer conductor container. The outer conductor container is in this case galvanically connected to an earthing surface. The inner conductor is connected at a first end galvanically and/or capacitatively to the container bottom of the outer conductor container, wherein a galvanic connection is used in particular in the design of the resonator as a /4 resonator, and preferably a capacitative connection is used with the design as a /2 resonator. The resonator is electrically coupled to the minimum of one bus strip via an opposed second end of the inner conductor. In this way, a high-frequency filter is created, which in its frequency behaviour corresponds essentially to a coaxial filter of conventional design, i.e. the filter has a narrow frequency band. As a departure from conventional coaxial filters, however, the resonator cavities are not formed as cast or milled parts, but separate resonators are used, consisting of an outer conductor container and an inner conductor, which are coupled in a simple manner by means of stripline technology to an electric lead. This high-frequency filter is substantially cheaper to manufacture in comparison with conventional coaxial filters, since the individual resonators can be manufactured separately by economical methods, and can then be coupled to a bus strip on a substrate, likewise manufactured separately. The high-frequency filter as claimed in the invention accordingly combines the stripline technique with resonators of coaxial design, and so creates a filter which can be manufactured more simply in comparison with conventional coaxial filters, and, in addition to this, is also of more compact design.

In a particularly preferred embodiment of the filter as claimed in the invention, air is arranged as the dielectric between the inner conductor and the side wall of the outer conductor container. Preferably, the filter is designed in such a way that the resonator is arranged on the second side of the substrate, i.e. on the side opposite the side with the bus strip applied to it. The earthing surface is in particular an essentially continuous conductive layer on the second side of the substrate, wherein the edge of the opening of the outer conductor container located opposite the container bottom is galvanically connected to the conductive layer, in particular soldered to it, wherein wave soldering is used in particular. In a preferred embodiment the conductive layer has ring-shaped cut-outs, which expose the dielectric material of the substrate, wherein the edge of the opening of the outer conductor container opposite the container bottom is arranged around the ring-shaped cut-out.

The second end of the inner conductor, by which the connection to the bus strip is achieved, is preferably secured to the substrate. In addition, the substrate has preferably on the second side a cut-out and/or a hole, into which the second end of the inner conductor is inserted and, in particular, is soldered in place. By contrast, the first end of the inner conductor is inserted preferably into a cut-out and/or a hole in the bottom of the outer conductor container of the resonator and in particular soldered and/or impressed there. The outer conductor container and the inner conductor can therefore be manufactured separately and only then be galvanically connected to one another. Further, in a particularly preferred embodiment, the axial direction of the resonator stands essentially perpendicular to the first and/or second side of the substrate.

The outer conductor container and/or the inner conductor can be manufactured in a simple manner. For example, these components may be turned metal components, or the components are plastic components which are metallised on the outer and/or inner surface. Preferably, the resonator is coupled capacitatively and/or inductively to the minimum of one bus strip, wherein the bus strip can, for example, have a meander-shaped structure. In particular, the bus strip can comprise branches, which form a circle and/or semicircle and/or a circle segment, wherein in each case the second end of the inner conductor is arranged in the middle.

In a further embodiment of the invention, a cover is provided on the first side of the substrate, wherein the cover has preferably at least one adjusting element aligned essentially axially with a coaxial resonator, for changing the electrical properties of the high-frequency filter. The adjusting element can, for example, be a metallic pin, capable of being displaced in the cover, and/or a metallic screw capable of being rotated in the cover.

In a particularly preferred embodiment, a plurality of resonators is arranged in the longitudinal direction next to the bus strip, wherein the resonators may have different sizes. The substrate is preferably a dielectric plate. The resonators are in particular coupled to the bus strip in such a way that a bandpass filter and/or a bandstop filter is formed. Preferably the high-frequency filter operates in the range of the 1800 MHz mobile radio frequency and/or the 2000 MHz mobile radio frequency.

Embodiment examples of the invention are described hereinafter on the basis of the appended Figures.

These show:

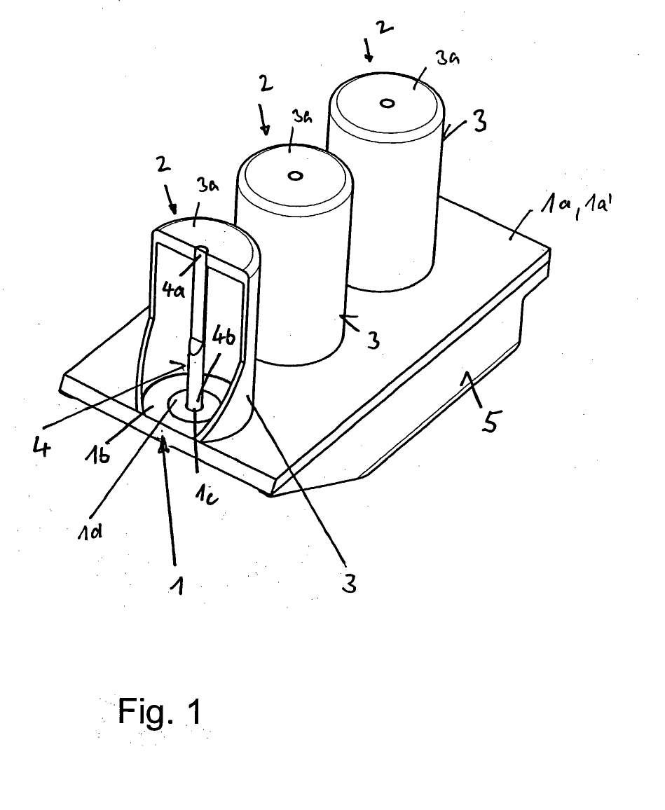

FIG. 1: A perspective, partially sectional view from above onto an embodiment of the high-frequency filter as claimed in the invention;

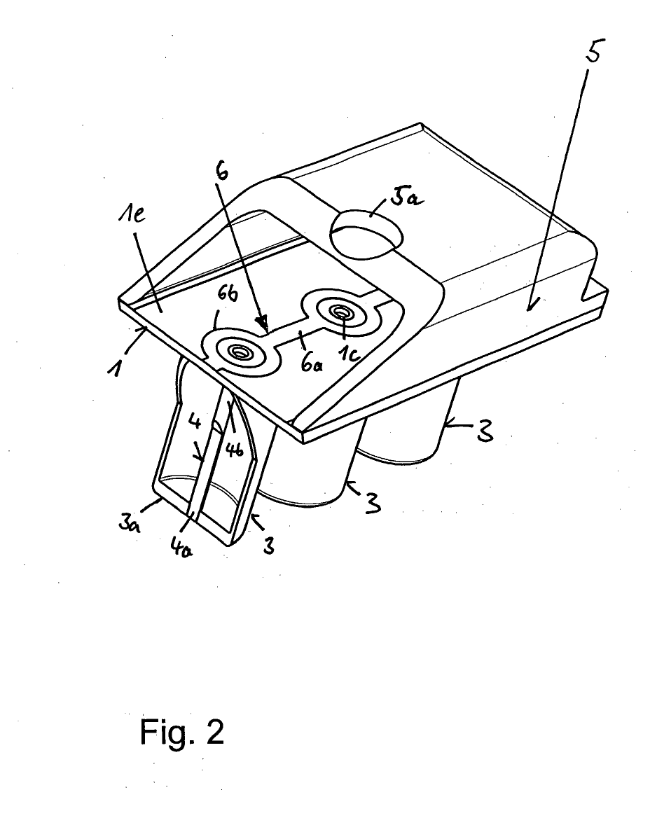

FIG. 2: A perspective, partially sectional view from below of the high-frequency filter as claimed in FIG. 1; and

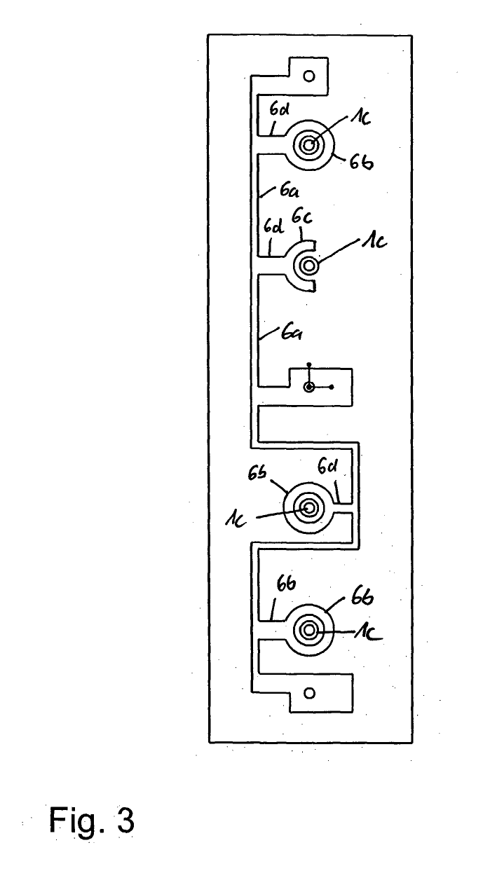

FIG. 3: A plan view of an embodiment of a bus strip used in the filter as claimed in the invention.

The high-frequency filter shown in FIG. 1 comprises a dielectric substrate plate 1, on the upper side of which three identical coaxial resonators 2 are arranged. It is possible, if appropriate, for fewer or more resonators to be arranged on the upper side, wherein in the case of more than three resonators FIG. 1 shows only a part section of the filter and the substrate plate continues in the longitudinal direction with additional resonators. The frontmost coaxial resonator is represented in a sectional view. Each coaxial resonator comprises a cylindrical pot-shaped outer conductor 3, which is, for example, a turned metal component. As an alternative, the outside conductor can be an injection moulded part, of which the outer and/or inner surface are enclosed and metallised. The outer conductor container 3 is located with its container opening downwards onto the upper side 1a of the substrate, so that the container bottom 3a is located at a distance from the upper side 1a. Arranged in the axial direction of the outer conductor container, concentrically in the middle, is a cylindrical inner conductor rod 4, which at its upper end 4a is inserted into a corresponding hole in the container bottom 3a and is soldered or impressed there. Between the inner conductor rod and the cylindrical side wall of the outer conductor container, air is provided for as the dielectric. The opposed lower end 4b of the cylindrical inner conductor rod 4 is inserted into a corresponding opening 1c in the substrate 1. The upper side 1a of the dielectric substrate 1 is essentially metallised throughout and forms an earthing surface 1a ′of the filter, wherein, however, ring-shaped cut-outs 1b are provided in the area of the circular container openings of the outer conductor containers 3, the said ring-shaped cut-outs 1b exposing the dielectric material of the substrate 1. The outer edge of each cut-out 1b in each case terminates in contact with an edge of the container opening of an outer conductor container, wherein the edge of the container opening on the outer face of the outer conductor container is galvanically connected to the metallic layer on the substrate, for example by wave soldering. In this way, the earth contact of the outer conductor container is established. Connected to the inner side of the ring-shaped cut-out 1b is a circular metallic section 1d, in the middle of which is located the opening 1c. Located on the underside 1e of the substrate 1 is a protective cover 5. The underside 1e is in this situation designated hereafter in part as the first side 1e and the upper side 1a in part also as the second side 1a.

FIG. 2 shows a perspective and partially sectional view of the filter from FIG. 1, from below. The housing 5 is here shown in section, so that the structure of the underside 1e of the substrate 1 can be seen. Located on the underside is a bus strip 6, which essentially extends in the longitudinal direction of the substrate plate. The bus strip comprises straight sections 6a as well as circular branches 6b, in the middle of which is located in each case the opening 1c, into which one end 4b of the inner conductor rod 4 is inserted. The opening 1c is in this situation metallised on the side 1e, wherein, however, the metal does not have any connection to the circular branches 6b. The inner conductor rod is soldered on the underside 1e at the opening 1c. Accordingly, via the inner conductor inserted into the opening 1c, a capacitative coupling of the coaxial resonator 2 to the bus strip 6 is established.

The cover 5 runs around the edge of the underside 1e of the substrate 1, so that the entire underside is surrounded by the cover. In addition, provided in the cover is a hole 5a, which is aligned in the axial direction with a resonator 2 located beneath it. An adjustment element can be inserted into this hole, which can, for example, be a metallic bolt displaceable perpendicular to the substrate plate 1. The distance between this bolt and the underside 1e of the substrate plate 1 can be changed by the adjustment element, as a result of which the frequency behaviour of the filter can be influenced. In this context, a plurality of adjustment elements can be provided, wherein each adjustment element is aligned in the axial direction with a resonator located beneath. The filter according to FIGS. 1 and 2 is used, for example, as a bandstop filter for separating the 1800 MHz mobile radio frequency from the UMTS mobile radio frequency in the 2000 MHz range. The filter in this situation is of narrower band in comparison with conventional stripline filters, and has steeper flanks. In its frequency behaviour the filter therefore corresponds to conventional coaxial filters in the form of metallic milled or cast components.

The resonators 3 shown in FIGS. 1 and 2 are /4 resonators, with which the length of the inner conductor rod 4 corresponds to a quarter of the wavelength . With these resonators the inner conductor rod 4 is galvanically connected at one end 4a to the container bottom 3a. It is also possible, however, for the resonators 3 to be used as /2 resonators, with which the length of the inner conductor rod 4 amounts to half of the wavelength . In this case, the end 4a of the inner conductor rod is capacitatively coupled to the container bottom, for example by the end 4a being connected to a metallic disk, the size of which corresponds essentially to the size of the container bottom 3a, and which is located at a distance from the container bottom. The capacitative coupling takes effect at the resonator frequency as a short-circuit.

The bus strip 6 shown in FIG. 2 represents only one possible embodiment. In particular, it is also possible for the bus strip to be designed in meander shape, and the circular branches 6b to be arranged offset to the straight sections 6a. In addition, the branches must not form a closed circle, but can also comprise only circle segments. FIG. 3 shows a plan view of the underside 1e of a substrate plate with such an alternative embodiment of the bus strip. It can be seen that branches in the form of closed circles 6b and branches in the form of circle segments 6c are provided, wherein the branches are in each case connected by means of webs 6d with straight sections 6a of a meander-shaped bus strip 6. In each case arranged concentrically to the branches 6b and 6c respectively is the opening 1c, into which the end 4b of the inner conductor rod 4 is inserted.

From the embodiments described it can therefore be seen that the electrically conductive outer conductor container 3 is electrically connected at its area located remote from the container bottom 3a, in particular at its open upper edge area opposite the container bottom 3a to the earthing surface 1a, preferably at the entire circumferential edge. Arranged coaxially to this is the inner conductor 4, which is connected galvanically or capacitatively to the container bottom. The electrical connection to the bus strip 6 is provided via the inner conductor 4, i.e. in the embodiment shown only and exclusively via the inner conductor 4. To achieve this, the inner conductor 4 is connected to the bus strip remotely from its end at which it is connected galvanically or capacitatively to the container bottom 3a. Preferably, this second connection to the bus strip 6, at the end of the inner conductor 4 located opposite the container bottom, likewise galvanic or capacitative.

1. A high-frequency filter, with the following features:
Provision is made for a substrate of dielectric material, with a first side and an opposite second side,
Located on the first side of the substrate is at least one bus strip,
Provision is made for at least one resonator, which is electrically coupled to the minimum of one bus strip,
Provision is made on the second side for an earthing surface located at a distance from the bus strip,
The minimum of one resonator is a coaxial resonator with an outer conductor container and an inner conductor, essentially rod-shaped and arranged coaxially in the outer conductor container, which comprises a first end and a second end opposite to the first end,
The outer conductor container is connected galvanically to the earthing surface,
The second end of the inner conductor is electrically coupled to the minimum of one bus strip,
characterised by the following further features:
The inner conductor is connected at a first end galvanically to the container bottom of the outer conductor container,
The minimum of one resonator is arranged on the second side of the substrate, on which the earthing surface is provided, and
The bus strip provided on the first side is provided on the side of the substrate located opposite the minimum of one resonator.

2. The high-frequency filter as claimed in claim 1, wherein the bus strip is electrically connected to the outer conductor container via the inner conductor.

3. The high-frequency filter as claimed in claim 1, wherein air is provided as the dielectric between the inner conductor and the side wall of the outer conductor container.

4. The high-frequency filter as claimed in claim 1, wherein the earthing surface is an essentially continuous conducting layer on the second side of the substrate, and the edge of the opening of the outer conductor container, opposite the container bottom, is galvanically connected to the earthing surface.

5. The high-frequency filter as claimed in claim 4, wherein the edge of the opening of the outer conductor container, opposite the container bottom, is soldered to the conductive earthing surface, in particular by means of wave soldering.

6. The high-frequency filter as claimed in claim 4, wherein the conductive earthing surface has at least one ring-shaped cut-out, which exposes the dielectric material of the substrate, wherein the edge of the opening of the outer conductor container, opposite the container bottom, is arranged around the ring-shaped cut-out.

7. The high-frequency filter as claimed in claim 1, wherein the second end of the inner conductor is secured to the substrate.

8. The high-frequency filter as claimed in claim 1, wherein the substrate has on the second side a cut-out and/or a hole extending to the first side, into which the second end of the inner conductor is inserted and, preferably, is soldered in place.

9. The high-frequency filter as claimed in claim 1, wherein the first end of the inner conductor is inserted into a cut-out and/or a hole in the container bottom of the outer conductor container, and preferably is soldered and/or impressed to the container bottom at the hole.

10. The high-frequency filter as claimed in claim 1, wherein the axial direction of the resonator stands essentially perpendicular to the first and/or second side of the substrate.

11. The high-frequency filter as claimed in claim 1, wherein the outer conductor container and/or the inner conductor is a turned metal component.

12. The high-frequency filter as claimed in claim 1, wherein the outer conductor container and/or the inner conductor is a plastic component, which is metallised on the outer and/or inner surface.

13. The high-frequency filter as claimed in claim 1, wherein the minimum of one resonator is coupled capacitatively and/or inductively to the minimum of one bus strip.

14. The high-frequency filter as claimed in claim 1, wherein the bus strip has at least in part a meander-shaped structure.

15. The high-frequency filter as claimed in claim 1, wherein the bus strip has one or more branches, which form a circle and/or a circle segment, wherein the second end of the inner conductor is arranged in the middle of the circle and/or the circle segment.

16. The high-frequency filter as claimed in claim 1, wherein a cover is provided on the first side of the substrate.

17. The high-frequency filter as claimed in claim 16, wherein provision is made in the cover for at least one adjustment element, aligned essentially axially with a resonator for changing the electrical property of the high-frequency filter.

18. The high-frequency filter as claimed in claim 17, wherein the minimum of one adjustment element is a metallic pin capable of being displaced in the cover and/or a metallic screw capable of being rotated in the cover.

19. The high-frequency filter as claimed in claim 1, wherein a plurality of resonators is arranged in the longitudinal direction next to the bus strip.

20. The high-frequency filter as claimed in claim 19, wherein the resonators have different sizes.

21. The high-frequency filter as claimed in claim 1, wherein the substrate is a dielectric plate.

22. The high-frequency filter as claimed in claim 1, wherein the minimum of one resonator is coupled to the bus strip in such a way that a bandpass filter and/or a bandstop filter is formed.

23. The high-frequency filter as claimed in claim 1, wherein the filter operates in the range of the 1800 MHz mobile radio frequency and/or the 2000 MHz mobile radio frequency.
